(19) United States
(12) Patent Application Publication
(10) Pub. No.: US 2012/0323499 A1
(43) Pub. Date: Dec. 20, 2012

(54) System for Measurement of Greenhouse Gas Generation from Fuel Combustion

(76) Inventors: Robert Emil Yelin, West Hills, CA (US); Shraga Agam, Encino, CA (US)

(21) Appl. No.: 13/517,531

(22) Filed: Jun. 13, 2012

Related U.S. Application Data
(60) Provisional application No. 61/497,896, filed on Jun. 16, 2011.
(60) Provisional application No. 61/497,889, filed on Jun. 16, 2011.
(60) Provisional application No. 61/564,269, filed on Nov. 28, 2011.

(51) Int. Cl. G06F 19/00

(52) U.S. Cl. 702/24

(57) ABSTRACT

The present disclosure relates to a system and method for determining amounts of carbon dioxide, other greenhouse gas (GHG), and/or toxic gaseous emissions from a mobile or stationary emissions source such as automobiles having an internal combustion engine, fossil-fuel or other hydrocarbon-burning facilities, or the like. The system and method may calculate the amount of GHG emissions by measuring fuel consumption and converting to GHG emissions based on the known carbon content for the fuel. The system and method disclosed further include the generation and distribution of reports related to fuel consumption and/or GHG emissions data. The system may be used to monitor and track fuel saving measures, enforce compliance to regulatory limits, carbon taxes, or cap-and-trade programs, and the like.

### CROSS-REFERENCE TO RELATED APPLICATIONS

This application claims priority under 35 USC §119 to the following applications: U.S. Provisional Patent Application Ser. No. 61/497,896, filed on Jun. 16, 2011, and titled “System for Measurement of Carbon Dioxide Generation from Fossil Fuel Combustion from Mobile Sources,” U.S. Provisional Patent Application Ser. No. 61/497,889, filed on Jun. 16, 2011, and titled “System for Measurement of Carbon Dioxide Generation from Fossil Fuel Combustion from Mobile Sources,” and U.S. Provisional Patent Application Ser. No. 61/564,269, filed on Nov. 28, 2011, and titled “System for Real-Time Measurement of Carbon Dioxide Generation from Fossil Fuel Combustion from Stationary Sources.” The entire contents of these three applications are hereby incorporated by reference.

### BACKGROUND

1. Technical Field

The present disclosure relates generally to a system for real-time monitoring of fuel usage and greenhouse gas emissions. More particularly, the disclosure relates to a system for monitoring stationary or mobile distributed internal combustion engines or other fossil fuel or other hydrocarbon-burning systems for compliance to regulatory limits, carbon taxes, cap-and-trade programs, and the like.

2. Background

Combustion of fossil fuels, which includes petroleum (oil), natural gas, and coal in automobiles, power plants, industrial facilities, and other sources, is the largest source of carbon dioxide emissions in the US. (See “Human-Related Sources and Sinks of Carbon Dioxide,” US EPA, http://www.epa.gov/climatechange/emissions/co2_human.html (last accessed May 28, 2012).) Carbon dioxide has been determined by the U.S. Environmental Protection Agency (EPA) to be a greenhouse gas (GHG), defined as a gas that may trap heat in the atmosphere,. A major source of carbon dioxide emissions is the collective group of automobiles currently in use. It was recently estimated that transportation accounts for approximately 27% of GHG emissions in the US. (See “Basic Information: Transportation and Climate,” US EPA, http://www.epa.gov/otaq/climate/basicinfo.htm (last accessed May 28, 2012).)

In response to increasing levels of carbon dioxide in the atmosphere, there are widespread regulatory and technological efforts underway to reduce carbon dioxide emissions from fossil fuel combustion and other carbon dioxide sources. There is also a common desire to reduce dependency on foreign sources of energy. Examples of regulatory efforts include regulatory limits, mandated reductions in GHG emissions and fossil fuel usage, federal and state cap-and-trade programs, and emission credits trading programs. Examples of technological efforts include various types of fuel management systems implemented to reduce the amount of fuel used and the resultant carbon dioxide emitted. Such regulatory programs and fuel saving measures could be greatly benefited by inexpensive, reliable, and accurate methods of measuring carbon dioxide emissions in real-time from the variety of emissions sources.

Currently, systems exist in the market that measure carbon dioxide emissions. However, such systems are typically not portable or real-time, and thus may not be feasible on automobiles and other mobile sources of GHG emissions in a real-world setting. For example, an automobile may be set up on a dynamometer to measure the torque output of the automobile engine and an engine emission gas analyzer or similar diagnostic equipment may be connected to the automobile's exhaust tail pipe to measure the volume of carbon dioxide emissions at various engine speeds. Test results may be interpolated and extrapolated to estimate carbon dioxide emissions at other engine/vehicle speeds. However, such tests are not only costly, time consuming, and temporarily remove the test vehicles from productivity, but the results are not practical due to differences in engine performance and emission generation between the simulated setting of a dynamometer and the changing environments of the real world. For example, variances that exist in the real world include driver behavior, weather, terrain, load, and tire pressure. These variances may continuously change during typical operation of the vehicle, thus affecting the actual GHG emissions in ways that the previous test results may not accurately reflect. Similar shortcomings exist for systems that measure GHG emissions from stationary sources.

As a further example, manual stack testing is typically labor-intensive, time-consuming, relatively expensive, and non-continuous. Continuous emission monitors (CEMs) are sometimes used on large stationary sources such as in an electricity-generating utility. A CEM is relatively expensive to purchase and may need to be regularly maintained (thus adding to the cost to operate).

An accurate, real-time system for measurement of carbon dioxide emissions from fossil fuel (or other hydrocarbon fuel) combustion could allow for the implementation of an emission credit trading program for mobile and stationary sources (an estimated worldwide multi-hundred-billion dollar market), which is not currently economically feasible. Such a system could aid in enforcement of regulatory limits to GHG emissions. In addition, it could aid in tracking the reduction of carbon emissions as a result of the implementation of fuel management systems or other fuel-saving measures.

What is needed, therefore, is a simple, effective and inexpensive way to accurately determine the amount of GHG produced and/or fuel consumed by combustion at a mobile or stationary source, in real-time, and in real world settings.

### SUMMARY

In one embodiment, a system for real-time monitoring of greenhouse gas emissions at a remote unit is disclosed, the system having at least one remote unit, a data controller, a global positioning satellite module, a communications module, a processor module, and a server. The remote unit is associated with an account. The data controller is adapted to gather information related to amounts of fuel at the remote location. The global positioning satellite module is adapted to provide location information to the data controller. The communications module is adapted to send datasets over a cellular network from the data controller, the datasets related to volumes of fuel at the remote unit and location information. The processor module is adapted to calculate the amount of greenhouse gas produced by the remote unit using the datasets related to amounts of fuel as a variable in calculations. The server is adapted to distribute information related to the amount of greenhouse gas produced by the remote unit to a user associated with the account.

In another embodiment, a method of real-time monitoring of carbon dioxide emissions from a fleet of vehicles is disclosed, comprising: associating the fleet of vehicles with an account; receiving a first dataset from a data controller via a communications module in each vehicle in the fleet, the first dataset related to a first fuel level in a fuel tank in each vehicle; receiving a second dataset from the data controller via the communications module in each vehicle in the fleet, the second dataset related to a second fuel level in the fuel tank in each vehicle; calculating a first fuel volume delta using the first and second datasets, the first fuel volume delta corresponding to a first aggregate amount of fuel consumed by the fleet of vehicles; calculating a first amount of carbon dioxide produced by the fleet of vehicles using the first fuel volume delta; and associating the first amount of carbon dioxide produced with the account.

In another embodiment, a method of real-time monitoring of carbon dioxide emissions is disclosed, comprising: receiving a first dataset from a data controller via a communications module at a remote unit, the first dataset related to a first fuel level in a fuel tank at the remote unit; receiving a second dataset from the data controller via a communications module, the second dataset related to a second fuel level in the fuel tank at the remote unit; calculating a fuel volume delta using the first and second datasets, the fuel volume delta corresponding to an amount of fuel consumed at the remote unit; calculating an amount of carbon dioxide produced at the remote unit using the fuel volume delta; and sending a third dataset to a user, the third dataset corresponding to the amount of carbon dioxide produced at the remote unit.

The present disclosure will now be described more fully with reference to the accompanying drawings, which are intended to be read in conjunction with both this summary, the detailed description, and any preferred or particular embodiments specifically discussed or otherwise disclosed. This disclosure may, however, be embodied in many different forms and should not be construed as limited to the embodiments set forth herein; rather, these embodiments are provided by way of illustration only so that this disclosure will be thorough, and fully convey the full scope of the invention to those skilled in the art.

### BRIEF DESCRIPTION OF THE DRAWINGS

This disclosure may be understood by reference to the following description taken in conjunction with the accompanying drawings, in which like reference numerals identify like elements, and in which:

FIG. 1 depicts an embodiment of the present disclosure adapted to monitor fuel consumption and greenhouse gas emissions from a vehicle;

FIG. 2 depicts an embodiment of the present disclosure adapted to monitor fuel consumption and greenhouse gas emissions from a stationary emissions source;

FIG. 3 illustrates a method of the present disclosure of determining greenhouse gas emissions from a vehicle;

FIG. 4 illustrates a method of the present disclosure of determining if fuel consumption at a remote unit is within an acceptable range and creating an alert if it is not;

FIG. 5 illustrates a method of the present disclosure of determining if a remote unit should be refueled and creating an alert if it should;

FIG. 6 illustrates a method of the present disclosure of determining if a fuel tank at a remote unit has an expected amount of fuel and creating an alert if it does not;

FIG. 7 is an example report reflecting carbon dioxide emissions of a specified vehicle;

FIG. 8 is an example refueling report reflecting carbon dioxide emissions;

FIG. 9 is an example report reflecting carbon dioxide emissions of an aggregate group of remote units; and

FIG. 10 is an example chart depicting 30-day moving average fuel consumption ratios for two vehicles.

### DETAILED DESCRIPTION

In the following description, reference is made to the accompanying drawings that form a part thereof, and in which is shown by way of illustration specific exemplary embodiments in which the invention may be practiced. These embodiments are described in sufficient detail to enable those skilled in the art to practice the invention, and it is to be understood that modifications to the various disclosed embodiments may be made, and other embodiments may be utilized, without departing from the spirit and scope of the present invention. The following detailed description is, therefore, not to be taken in a limiting sense.

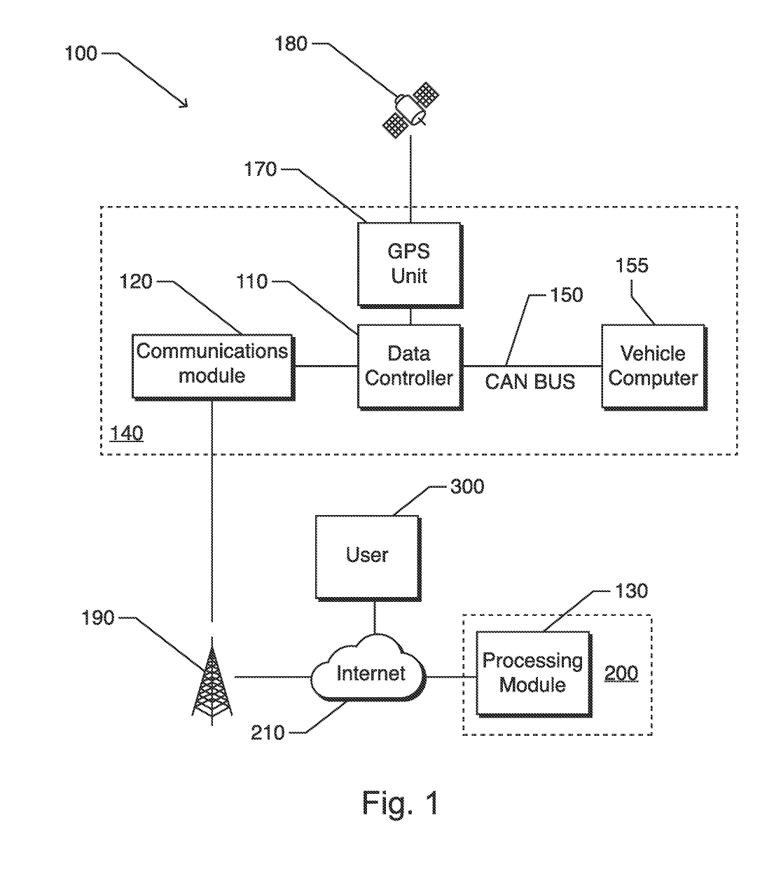

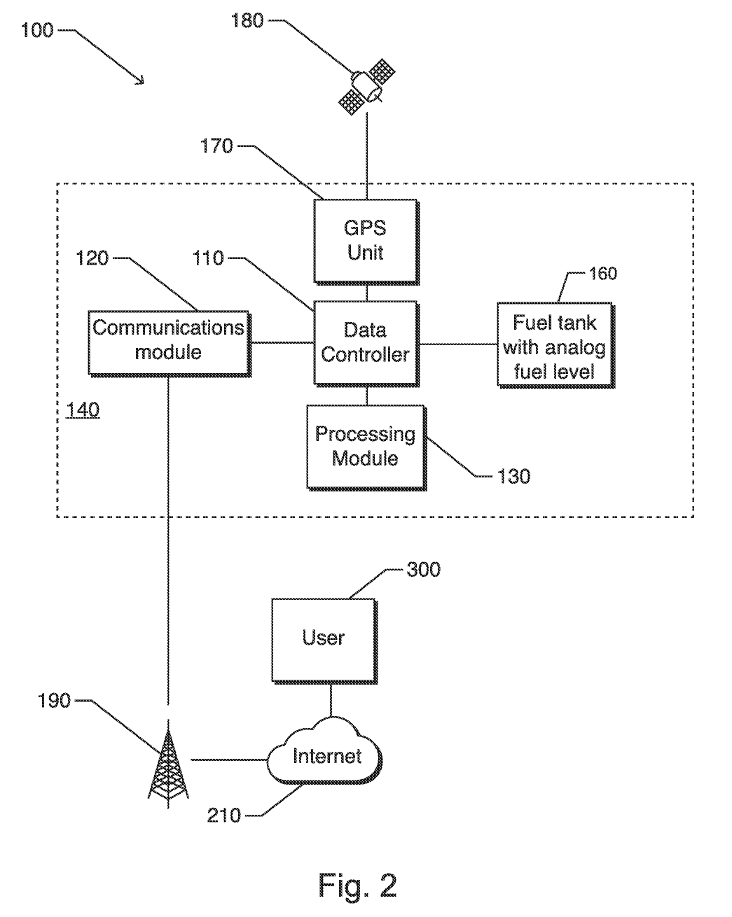

With reference to FIG. 1, an embodiment of the present disclosure comprises a system 100 for real-time monitoring of fuel usage and greenhouse gas emissions having a data controller 110, a communications module 120, and a processing module 130. The data controller 110 is located at a remote unit 140, which comprises a mobile (depicted in FIG. 1) or stationary (depicted in FIG. 2) greenhouse gas (GHG) emissions source. Examples of mobile GHG emissions sources include automobiles, marine vehicles, airplanes, trains, construction vehicles, or other machinery that employs internal combustion or other hydrocarbon fuel-powered engines. Examples of stationary GHG emissions sources include industrial facilities, electric utilities, broilers, generators (including portable generators), water pumping stations, refinery stacks, oil well pumps, and the like. As one of ordinary skill in the art having the benefit of this disclosure would understand, the present disclosure could be applied to virtually any process in which hydrocarbon fuels or the like are burned or otherwise processed, thereby producing carbon dioxide or other GHGs. The foregoing examples of mobile and stationary GHG emission sources are not to be taken in a limiting sense.

The data controller 110 is adapted to collect data related to fuel volume, flow rate, and/or consumption rate in the remote unit 140. In embodiments, the data controller 110 is installed within a vehicle and connected to that vehicle's controller area network (CAN) bus 150, which gathers data from the vehicle's engine and other systems, including vehicle computer 155, and from which the data controller 110 may retrieve data related to fuel volume and/or fuel consumption. Additional data may be passed from the CAN bus 150 to the data controller 110, which additional data is related to the vehicle's systems. Alternatively, the data controller 110 may gather fuel consumption and/or fuel volume data directly from any one of a variety of sensors installed in the vehicle, such as a fuel level sensor 160 (depicted in FIG. 2) or flow-rate sensors. Such direct acquisition of data may be useful in certain vehicles that are not equipped with a CAN bus. Alternatively, due to specific characteristics of certain vehicles, acquiring fuel-related data directly from one or more sensors installed on a fuel tank may be preferred over data acquisition from a CAN bus even for vehicles that are equipped with a CAN bus.

As one of ordinary skill in the art understands, CAN bus is a standardized vehicle information communication protocol that allows computers, devices, and the like to communicate directly with each other. Using the standard CAN bus protocols, the data controller 110 may receive electrical signals from the sensor of a fuel management system, from the vehicle's fuel level sensor, or from other devices or sensors in the vehicle that detect or measure fuel volume, fuel flow rate, or other similar indicia of fuel usage and vehicle operation.

In other embodiments of the present disclosure, the data controller 110 is configured to receive data over an analog or digital connection with a fuel level sensor, fuel flow-rate sensor, or other sensor or indicator that outputs data related to fuel volume or usage by the remote unit 140. In certain embodiments, the data controller 110 communicates with fuel sensors that measure the amount of fuel delivered to a fuel tank and/or the amount of fuel in a fuel tank. For example, the fuel sensor may be positioned at the inlet of a fuel tank to allow measurement of the amount of fuel delivered. Data related to fuel volume, fuel consumption, or other parameters as measured may be communicated to the data controller 110 via wire or wirelessly by analog or digital signals.

Examples of fuel sensors that may be used in conjunction with the method and system of the present disclosure include the KEPC 61 and the KEPC 65, which are fuel sensors manufactured by Elicitop, an Israeli company. The KEPC 61 and KEPC 65 measure the pressure differences between the top and bottom of a fuel tank using pressure diaphragms and translate the pressure level to electrical signals that correspond to fuel levels and may be read by the data controller 110.

The data controller 110 is configured to collect and store fuel volume and/or fuel consumption data relating to the remote unit 140 and pass the data to the communications module 120. The data controller 110 includes a central processing unit (CPU) for processing data and a memory. The data controller 110 may include various other software, firmware, and/or devices such as a power source or power supply connection and an interface with either the CAN bus 150 or analog fuel measurement system 160.

The data controller 110 contains a set of computer-readable instructions embedded in a memory device such as a non-transitory computer-readable medium. The memory device can be, for example, a hard drive or an integrated circuit memory device, such as EPROM, EEPROM or flash memory devices, or any other suitable memory device. The computer-readable instructions can be stored as software or firmware and may be executed by a CPU to calculate carbon emissions based on the fuel consumption data. The computer-readable instructions may include any suitable technique for calculating the carbon emissions, as will be further described below.

The data controller 110 may collect additional data related to the operation or status of the remote unit 140. For example, such additional data may include location and/or velocity data collected from a global positioning system (GPS) unit 170 in communication with one or more GPS satellites 180 or similar location module, ambient air pressure data collected from a pressure transducer or the like, vehicle tire pressure data collected from installed pressure transducers or from a vehicle CAN bus 150 or similar system, ambient and/or operating temperature, and humidity.

The communications module 120 is configured to transmit data from the data controller 110 to the processing module 130 over a wireless communication system 190 such as a cellular or GPRS communication network or any other communication protocol including radio frequency (RF) protocols, Wi-Fi, wireless protocols employed by GPS, or the like.

Examples of a data controller 110 and communications module 120 that may be used in conjunction with the method and system of the present disclosure are embodied in the KIC 100 and the KC 100, respectively. Both units are manufactured by Elicitop. The KC 100 is an interface communication unit that allows connectivity with multiple sensors/alert units, a power supply for sensors/alert units, and a built-in cellular modem. The KIC 100 is a controller that may interface with multiple KC 100s to collect, process, and distribute data.

The KIC 100 may transmit data at pre-set time intervals (e.g., every 15 minutes or every hour) or when an alert is activated (e.g., refueling or fuel theft attempt). Other similar components may be utilized for the data controller 110 and communications module 120. Other such data controllers 110 and communications modules 120 may likewise communicate with the processing module 130 at pre-determined time intervals or upon certain activating conditions/alarms.

The processing module 130 is configured to receive data via the communications module 120 from one or more remote units 140. The processing module 130 is adapted to collect, organize, process, and distribute data collected from the one or more communications modules 120. The processing module 130 may comprise a server 200 connected to the Internet 210 or other network over which data may be transmitted. Alternatively, the processing module 130 may be implemented using distributed “cloud” technology rather than a single, dedicated server. In an alternative embodiment, the processing module is located on or at the remote unit 140.

The processing module 130 contains a set of computer-readable instructions embedded in a memory device such as a non-transitory computer-readable medium. The memory device may be, for example, a hard drive, an integrated circuit memory device, such as EPROM, EEPROM or flash memory devices, or any other suitable memory device. The computer-readable instructions can be stored as software or firmware and may be executed by a CPU to calculate GHG emissions based on the fuel consumption data. The computer-readable instructions may include suitable techniques for calculating the GHG emissions, as will be further described below. The processing module 130 contains additional computer-readable instructions that include steps for the processing module 130 to selectively generate reports 400 and provide specific information to a customer or agency, as needed. The processing module 130 is further configured to receive commands from a user 300 or operator related to its data gathering and reporting functions.

The computer-readable instructions for carrying out the processes of the present disclosure may be embodied in any non-transient computer-readable media. The computer-readable media may be for use by or in connection with any machine instruction execution system such as a processor, a field-programmable gate array (FPGA), an application-specific integrated circuit (ASIC), or any other system that can fetch or obtain the logic from the computer-readable media and execute the instructions contained therein. The computer-readable media may be any non-transient media that can contain, store, or maintain programs and data for use by or in connection with the instruction execution system. Examples of suitable computer-readable media include electronic, magnetic, optical, electromagnetic, and semiconductor media. More specific examples include a floppy diskette, a CD, or hard drive, a random access memory (RAM), a read-only memory (ROM), and an erasable programmable read-only memory (EPROM).

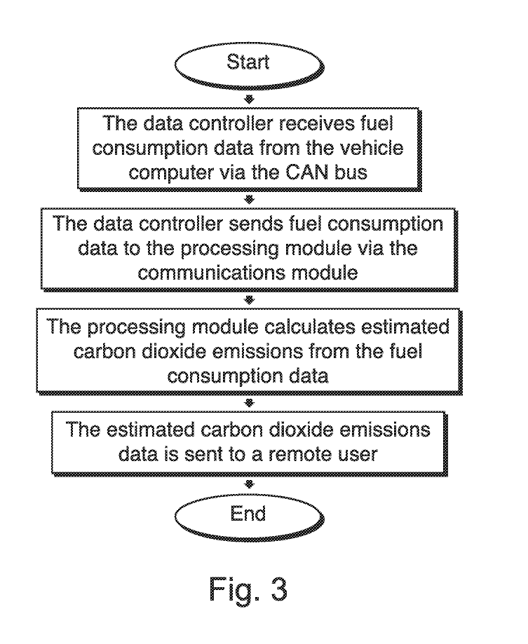

In operation, systems of the present disclosure 100 can be used to carry out a method of providing real-time GHG emission data for a relevant time period. The method may include receiving fuel consumption data at the data controller 110 of one or more remote units 140 and determining the amount of fuel used by the remote unit(s) 140 over any relevant time period. In the method depicted in FIG. 3, the fuel consumption data is sent from the data controller 110 to the processing module 130 via the communications module 120. The processing module 130 determines the calculated carbon dioxide (or other GHG) amount emitted by each remote unit 140 for that time period using the formula and conversion factors described herein. In an alternative embodiment, the data controller 110 may receive real-time rate of fuel consumption data from the CAN bus 150, analog measurement system 160, or the like, in which case the data controller 110 may calculate and/or transmit the rate of GHG emissions in real-time. Other possible methods of calculating emissions data from the fuel consumption data could be used and fall within the scope of this disclosure.

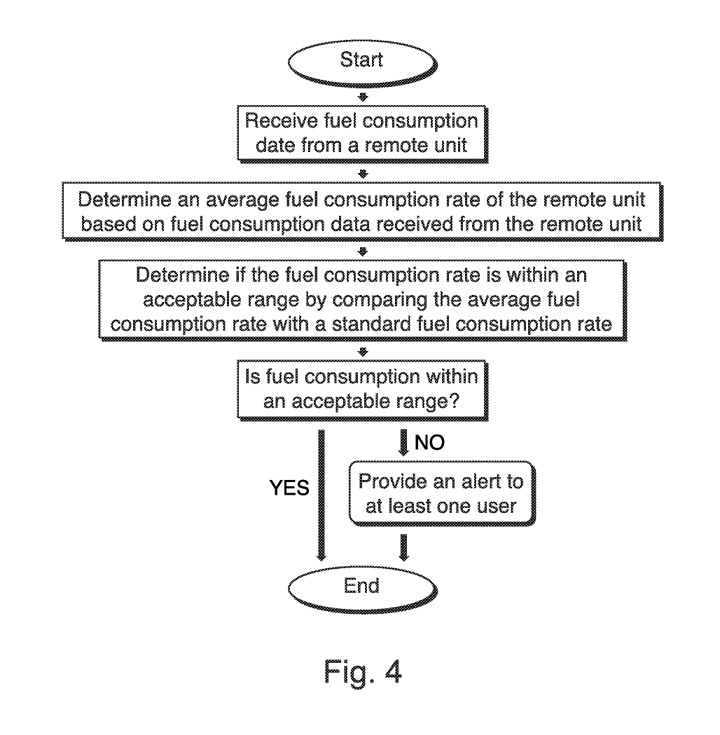

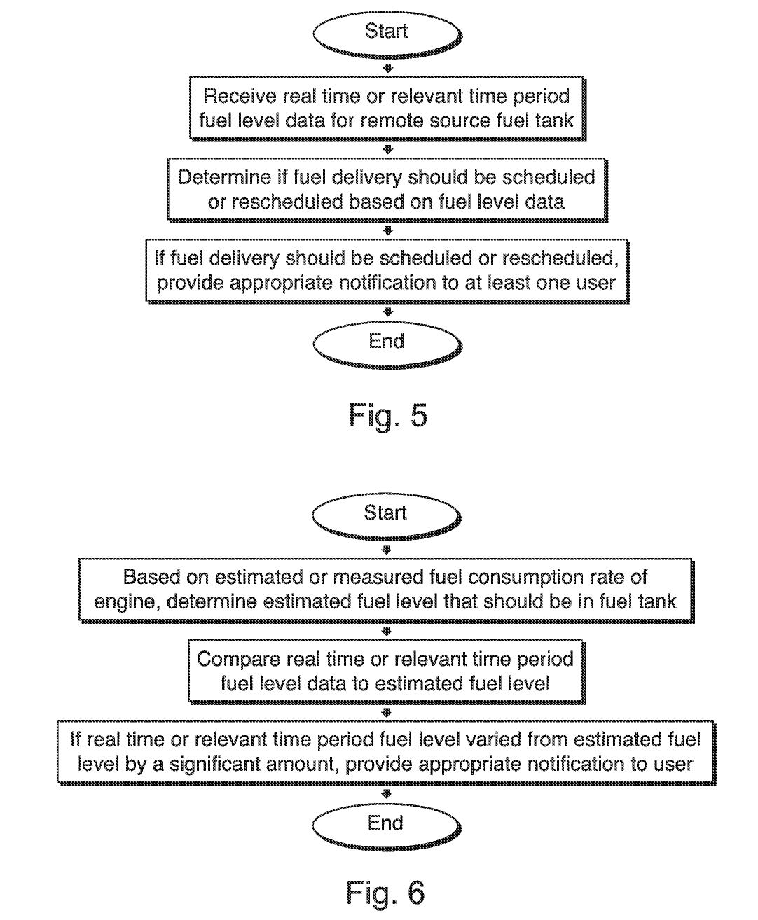

As depicted in FIG. 4, the method disclosed herein may further include monitoring the fuel consumption rate and alerting a user 300 if the fuel consumption rate is outside acceptable levels. As depicted in FIG. 5, the method may further include monitoring the fuel level at the remote unit 140 and alerting a user 300 if the fuel level is low enough that fuel delivery should be scheduled. As depicted in FIG. 6, the method may further include alerting a user 300 if the system detects any unexpected variances in the fuel level (which may be caused by leakage, theft, or the like).

The formula and conversion factors as employed in the present disclosure are based on a predetermined, constant, and standard amount of carbon content in any particular fuel. The conversion utilizes assumptions regarding how much of the carbon is released as carbon dioxide during the combustion process. For example, a gallon of gasoline may typically have 2,421 grams of carbon, and it may be assumed, for example, that 99% of the carbon content in the gallon of fuel will be oxidized during combustion (i.e., this particular application has an oxidation factor of 0.99), although the oxidization factor may be varied to suit each particular application.

To calculate the carbon dioxide emissions that results from combustion of a certain volume of fuel, the system and method disclosed uses the known stoichiometric ratio of carbon to oxygen in carbon dioxide and the atomic weight of each constituent atom: for every 12 grams of carbon oxidized during combustion, roughly 44 grams of carbon dioxide are created and emitted. As an example calculation, if 3.7 gallons of gasoline were consumed, assuming an oxidation factor of 0.99, the calculation to determine carbon dioxide emission would follow these steps:

$$\begin{matrix}3.7 gallons \times 2 \text{,} 421 \frac{ {grams}_{carbon}}{gallon} = 8 \text{,} 958 {grams}_{carbon} & ( 1 ) \\ 8 \text{,} 958 {grams}_{carbon} \times 0.99 = 8 \text{,} 868 {grams}_{carbon} & ( 2 ) \\ 8 \text{,} 868 {grams}_{carbon} \times \frac{ 44 {grams}_{{CO}_{2}}}{12 {grams}_{carbon}} = 32 \text{,} 520 {grams}_{{CO}_{2}} & ( 3 )\end{matrix}$$

Accordingly, while the remote unit 140 consumed 3.7 gallons of gasoline, it emitted approximately 32,520 grams of carbon dioxide. This result may be selectively converted to other units of weight or mass by trivial calculation. As one of ordinary skill in the art having the benefit of this disclosure would understand, as long as one knows the carbon content of a fuel and the oxidation ratio, he can calculate the approximate amount of carbon dioxide produced during combustion of that fuel.

While the carbon content figures are employed in the foregoing example illustrating a method for calculating carbon dioxide emissions, any other suitable carbon content figures, estimates, or measured values could be employed. The EPA has developed and published data pertaining to conversion factors to calculate emissions of GHGs for various types of fuels. (For example, see “Emission Facts: Average Carbon Dioxide Emissions Resulting from Gasoline and Diesel Fuel,” US EPA, February 2005, EPA420-F-05-001, available at http://pbadupws.nrc.gov/docs/ML1204/ML120440122.pdf (last accessed May 22, 2012), which is fully incorporated herein by reference.) Other similar conversion factors may be available for emissions calculations for other fuel types. Further, the carbon content estimates may vary depending on the fuel used, including the amount of additives, such as ethanol or methyl tertiary-butyl ether, in the fuel. Alternative embodiments of the method disclosed herein include determining the fuel and/or additive type and using known carbon content values for the specific fuel and/or additive type detected.

The processing module 130 can send the calculated emissions data to a user 300 of the data. For example, the data can be sent to a remote server 200 or user's 300 computer via the Internet 210. The user 300 may be an automobile fleet owner or manager, government agency or emissions authority, carbon emissions tracking entity, cap-and-trade entity, permit compliance entity, private vehicle owner, or any other entity that may make use of fuel consumption, efficiency, or emissions data.

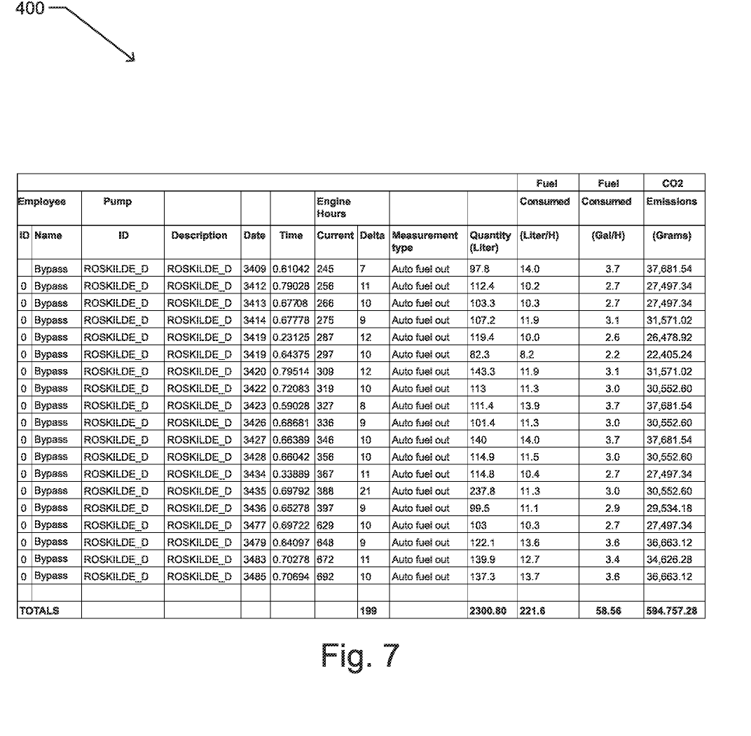

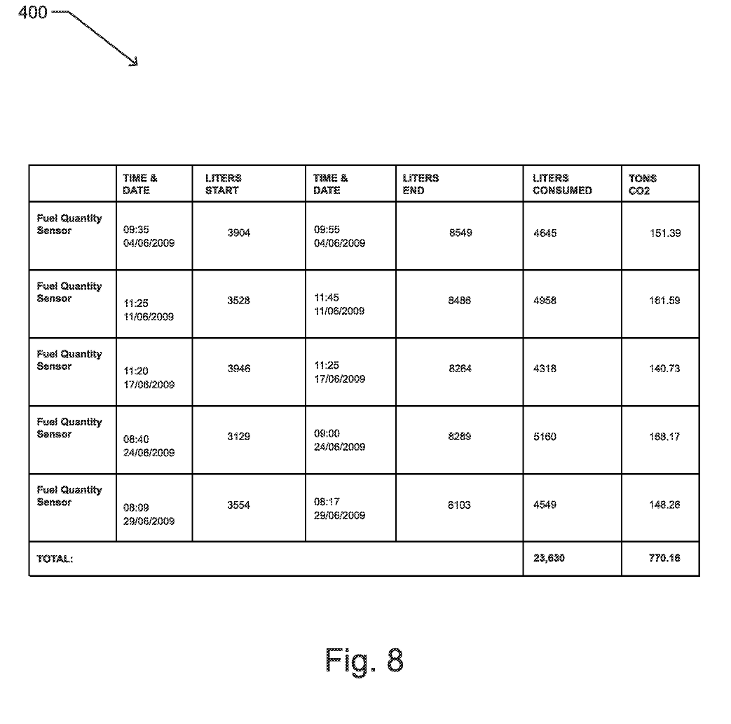

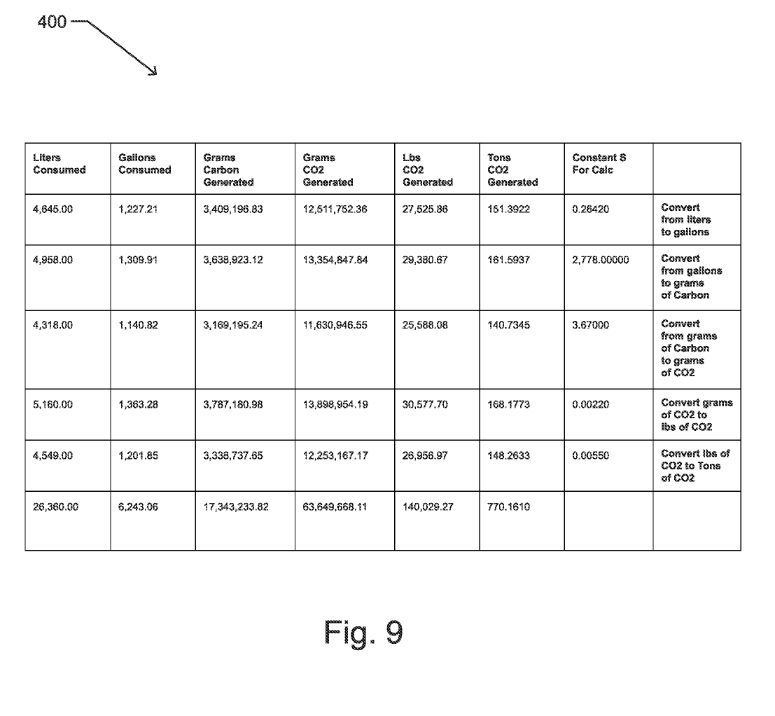

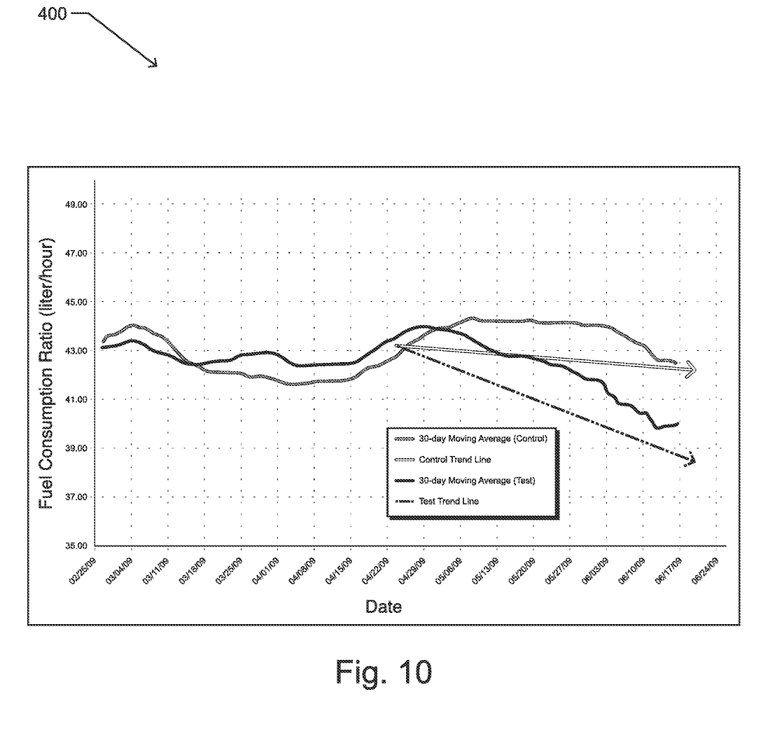

The processing module 130 may periodically send GHG emission data or fuel consumption data from one or more remote units 140 to one or more users 300. The data may be compiled and stored in a computer-readable medium, such as a hard drive, a read-only memory device, a USB memory storage device, or any other suitable memory device or data storage system. The collected data may be used to prepare reports 400 indicating the amount of carbon dioxide or other GHG emitted from one or more remote units 140 for a relevant reporting period, as shown in FIGS. 7-9. Reports 400 may include other data in addition to GHG emissions such as hours of operation, fuel consumed, fuel economy, cost information, mileage, engine idle time, driving time, engine ignition time, average speed, average engine revolutions per minutes (RPM), maximum RPM, duration that RPMs exceeded a pre-selected limit, number of engine revolutions that exceeded a pre-selected RPM limit, selected data trends, and so forth. The report 400 can include charts or other graphical depictions of relevant data or other known methods to depict data graphically, as depicted in FIG. 10.

A report 400 may be used by the user 300 or sent to a third party to provide information on a remote unit 140, including carbon dioxide emissions data. For example, user 300 may be a fleet manager, who periodically produces the report 400 and forwards it to a government agency for regulatory emissions limit compliance or cap-and-trade purposes. In another example, the user 300 may be an entity that tracks carbon dioxide emissions data and prepares the reports 400 for customers, fleet owners, or managers. The report 400 may present GHG emission data from multiple remote units 140 in aggregated form, or may provide such information on an individual unit basis. For example, emissions data for multiple stacks in a power plant may be combined and reported as emissions from the entire plant. The report 400 may include GPS or other location information to be associated with each remote unit 140.

The report 400 may be customized by the user 300 to include any possible combination of collected data. The user 300 may selectively tailor the data collected for each remote unit 140. Alternatively, the user 300 may selectively tailor the data collection intervals for each remote unit 140. For example, the data controller 110 of some remote units 140 may collect data only once every 30 minutes, whereas other remote units 140 have data controllers 110 that collect data every 60 seconds. Such customization may be implemented by a user 300 sending commands through a graphical user interface to the processing module 130, which would, in turn, transmit commands to the data controller 110 to execute the selected customizations by the user 300. The report 400 may be made accessible to a user 300 over the Internet 210. Data may be continually updated for the user 300 as it is received from the data controller 110 via the communications module 120. Real-time or near real-time alerts may be sent to users 300 through the graphical user interface, through electronic mail, Short Message Service (SMS) text messaging, or through other means known in the art.

The system and method of the present disclosure have many foreseeable uses to monitor and evaluate the use of fuel management systems to reduce fuel consumption and carbon dioxide emissions. By implementing the system and method disclosed herein, one can determine baseline fuel consumption and carbon dioxide emission levels, install one or more fuel management, fuel reduction, and/or emissions reduction systems, and determine the impact of such systems to the fuel efficiency and reduction in carbon dioxide emission.

The system and method of the present disclosure may be utilized to monitor the efficiency of one or more remote units 140 on a near-continuous basis. Mechanical or other problems may be identified and pinpointed relatively early and subsequently rectified by applying corrective maintenance and tuning, thereby reducing repair costs and waste. Fuel theft or other loss (such as leakage) could be identified by comparing measured fuel levels with purchasing records or the like. The disclosed system has the ability to produce an alert to a user 300, such as a vehicle fleet manager, when such problems arise and the user's attention is needed. For remote units 140 that are stationary and have relatively constant fuel consumption rates, the processing module 130 could create an alarm when the fuel consumption rate changes from its baseline or other pre-determined level. By providing an early alert for problems or maintenance needs, modifications or corrections can be applied quickly, thereby preventing further damage and increasing efficiency.

Embodiments of the system allow the user 300 to selectively create one or more alert conditions depending on the user's specific application and needs or as desired. The user 300 may specify any number of alert conditions via the Internet through a graphical user interface in a web browser or the like. After the user 300 has specified one or more alert conditions, the system activates those alert conditions by monitoring any relevant parameters and comparing measured data to the alert level(s) defined by the user 300. In alternative embodiments, alert conditions follow regulatory limits or other predetermined levels. Upon satisfaction of such user-specified alert conditions, the system may notify the user 300 or other third party that the specified alert condition(s) have been met. Notification may be accomplished through any known means.

Embodiments disclosed may include security measures to prevent tampering and other unauthorized access. For example, embodiments include casing and/or an alarm. The casing comprises hard, durable panels in a structure that secures and protects some or all system components from tampering, weather, or the like. In certain embodiments, the casing includes a locking mechanism and/or tamper-evident seals to prevent unauthorized access to the internal components. In other embodiments, the casing has weather-proof seals. Embodiments include sensors that detect unauthorized access to components of the disclosed system. If a would-be vandal attempts to open the casing or otherwise gain access to the components, the sensors may trigger an alarm locally and/or remotely to alert a user 300.

Additional alert triggers may be implemented in the system. In alternative embodiments, data collected includes the identity of the drivers of each vehicle. The system tracks fuel efficiency, vehicle speed, and other factors in association with each driver and can output reports 400 reflecting each driver's driving habits. Such driver data may be collected across multiple vehicles for any driver in order to assemble an accurate and complete picture of driver performance. If a driver's fuel efficiency is lower than baseline (which can be determined for each of the various vehicles operated by the driver) and/or the driver's driving behavior is deemed to constitute unsafe driving, the system may be configured to alert the user 300 and/or the driver. Possible responses to this alert may include requiring the driver to submit to additional training of fuel-efficient and/or safe driving techniques, censuring the driver for inefficient and/or unsafe driving, or other like responses to attempt to correct the deficiencies in the driver's behavior. Such monitoring and corrective actions may be taken automatically by the processing module and auxiliary systems.

As an additional example application, the disclosed system may be implemented in a fleet of delivery vehicles. GPS units 170 or the like installed in each delivery vehicle may provide location information that can be associated with products, packages, or other deliveries that have been loaded into the delivery vehicle. The intended recipient may receive shipping status updates through a graphical web interface, SMS text messaging, electronic mail, or the like. Additionally, when the delivery vehicle is near the delivery location for any product or package, the intended recipient may be alerted regarding the imminent delivery.

The system and methods disclosed herein may be utilized in cap-and-trade programs. For example, if one entity reduced its carbon dioxide (or other GHG) emissions rate, and could track its amount of emissions “savings,” that entity could gain emission credits from an issuing body and subsequently trade those credits to another entity that needed to offset its emissions because it was releasing GHGs above its cap. Alternatively, the system and method may be used to monitor and ensure compliance to mandates for lowering fuel consumption and/or GHG emission levels. In such cases, the data may be communicated directly from the processing module 130 to a government entity or other body employed in regulatory compliance. One of ordinary skill in the art having the benefit of this disclosure would understand that many other applications of the system are foreseeable and fall within the scope of this disclosure.

The system and method of the present disclosure may be used with any suitable type of fuel, including gasoline, diesel fuels, alternative fuels such as ethanol and other biofuels, or any other hydrocarbon fuel. As would be understood by one of ordinary skill in the art having the benefit of this disclosure, the formulas and conversion factors employed may be varied to match the type of fuel used and based on the known carbon content of that fuel.

An alternative embodiment of the disclosed system may include sensors and modules adapted to collect, aggregate, and report data for other pollutant emissions such as nitrogen oxides, sulfur dioxide, ozone, carbon monoxide, benzene and other volatile organic compounds (VOCs), and other gaseous pollutants that are typically emitted from motor vehicles and stationary sources. As described above, data regarding these other pollutant emissions may be used in regulatory enforcement applications (such as permit compliance), cap-and-trade operations, and the like.

These other gaseous pollutants may be detected and measured with commercially-available sensors mounted at the exhaust of the combustion source. Such sensors may comprise a bundle of different gaseous air pollutant sensors that make it possible to measure simultaneously more than one gaseous pollutant from a combustion source. The data related to the quantity of each of these other pollutant emissions from the combustion source, as detected by air-pollutant sensors, may be entered into an available channel of the data controller 110.

By measuring the amount of emissions of these other pollutant(s) generated by the combustion source per the amount of fuel consumed at the same time, one may calculate the ratio of pollutant per quantity of fuel consumed. Using both that ratio and continued measurements of the pollutants of interest, one may estimate the quantity of emissions of the pollutants of interest within any relevant time period of interest to the owner/operator of the remote unit 140. That data can be subsequently employed for a myriad of reasons including bundling quantity of pollutant(s) from either the mobile or stationary source(s) for an emission credit trading market, maintenance, regulatory compliance, and the like.

Although the present disclosure uses terms of certain embodiments, other embodiments will be apparent to those of ordinary skill in the art having the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. A system for real-time monitoring of greenhouse gas emissions at a remote unit, comprising:
at least one remote unit associated with an account;
a data controller at the remote unit adapted to gather information related to amounts of fuel at the remote location;
a global positioning satellite module at the remote unit adapted to provide location information to the data controller;
a communications module at the remote unit adapted to send datasets over a cellular network from the data controller, the datasets related to volumes of fuel at the remote unit and location information;
a processor module adapted to calculate an amount of carbon dioxide produced by the remote unit using the datasets related to amounts of fuel as a variable in calculations; and
a server adapted to distribute information related to the amount of carbon dioxide produced by the remote unit to a user associated with the account.

2. A method of real-time monitoring of carbon dioxide emissions from a fleet of vehicles, comprising:
associating the fleet of vehicles with an account;
receiving a first dataset from a data controller via a communications module in each vehicle in the fleet, the first dataset related to a first fuel level in a fuel tank in each vehicle;
receiving a second dataset from the data controller via the communications module in each vehicle in the fleet, the second dataset related to a second fuel level in the fuel tank in each vehicle;
calculating a first fuel volume delta using the first and second datasets, the first fuel volume delta corresponding to a first aggregate amount of fuel consumed by the fleet of vehicles;
calculating a first amount of carbon dioxide produced by the fleet of vehicles using the first fuel volume delta; and
associating the first amount of carbon dioxide produced with the account.

3. The method of claim 2, further comprising:
applying at least one fuel-saving measure to the fleet of vehicles;
receiving a third dataset from the data controller via a communications module in each vehicle in the fleet, the third dataset related to a third fuel level in the fuel tank in each vehicle;
receiving a fourth dataset from the data controller via a communications module in each vehicle in the fleet, the fourth dataset related to a fourth fuel level in the fuel tank in each vehicle;
calculating a second fuel volume delta using the third and fourth datasets, the second fuel volume delta corresponding to a second aggregate amount of fuel consumed by the fleet of vehicles;
calculating a second amount of carbon dioxide produced by the fleet of vehicles using the second fuel volume delta; and
associating the second amount of carbon dioxide produced with the account.

4. The method of claim 3, further comprising comparing the first amount of carbon dioxide produced with the second amount of carbon dioxide produced to determine a carbon dioxide emissions improvement measurement.

5. The method of claim 3, further comprising constructing a table depicting the first or second amounts of carbon dioxide produced by one or more vehicles in the fleet, the table adapted to be displayed to a remote user on a computer screen.

6. The method of claim 2, further comprising gathering data from a vehicle controller area network bus.

7. The method of claim 2, further comprising sending an alert to an agent associated with the account if the first amount of carbon dioxide produced or the first fuel volume delta exceed predetermined limits.

8. The method of claim 2, wherein the fleet of vehicles is a fleet of delivery vehicles, further comprising:
associating a delivery item with an intended recipient;
loading the delivery item into a vehicle in the fleet of delivery vehicles;
collecting location information for the vehicle by a location module installed on the vehicle; and
alerting the intended recipient regarding a location of the vehicle.

9. The method of claim 2, further comprising:
receiving a third dataset from the data controller via the communications module, the third dataset related to a distance traveled by the vehicle; and
calculating an amount of fuel consumed per distance traveled by the vehicle.

10. The method of claim 9, further comprising:
associating at least one driver with the account;
tracking the amount of fuel consumed per distance traveled while the driver operated the vehicle; and
creating an alert if the amount of fuel consumed per distance traveled while the driver operated the vehicle exceeds a certain limit.

11. A method of real-time monitoring of carbon dioxide emissions, comprising:
receiving a first dataset from a data controller via a communications module at a remote unit, the first dataset related to a first fuel level in a fuel tank at the remote unit;
receiving a second dataset from the data controller via the communications module, the second dataset related to a second fuel level in the fuel tank at the remote unit;
calculating a fuel volume delta using the first and second datasets, the fuel volume delta corresponding to an amount of fuel consumed at the remote unit;
calculating an amount of carbon dioxide produced at the remote unit using the fuel volume delta; and
sending a third dataset to a user, the third dataset corresponding to the amount of carbon dioxide produced at the remote unit.

12. The method of claim 11, wherein the remote unit is a stationary source.

13. The method of claim 11, wherein the remote unit is a vehicle.

14. The method of claim 13, wherein receiving a first dataset from a data controller via a communications module at a remote unit comprises retrieving fuel usage data from a controller area network bus in the vehicle.

15. The method of claim 14, further comprising:
receiving a fourth dataset from the data controller via the communications module at the remote unit, the fourth dataset related to a distance traveled by the vehicle; and
calculating an amount of carbon dioxide produced per distance traveled by the vehicle.

16. The method of claim 11, further comprising crediting the amount of carbon dioxide produced at the remote location to an account associated with an emission credit trading program.

17. The method of claim 11, further comprising recording a transaction of emission credits based on the amount of carbon dioxide produced at the remote unit.

18. The method of claim 11, further comprising:
receiving an input from the user, the input describing a user-specified alert condition;
activating the user-specified alert condition; and
conveying a notification upon the user-specified alert condition being satisfied.

19. The method of claim 11, further comprising:
collecting a fourth dataset, the fourth dataset related to a time interval and calculating an amount of carbon dioxide produced per time interval at the remote unit.
